(19) United States
(12) Patent Application Publication
(10) Pub. No.: US 2012/0302169 A1
(43) Pub. Date: Nov. 29, 2012

(54) BLUETOOTH DATA TRANSMISSION SYSTEM AND METHOD

(75) Inventors: PEI-HSIN LIN, Ta Ya Shiang (TW); Yu-Wen Hsu, Ta Ya Shiang (TW); Chih-Hsien Yao, Ta Ya Shiang (TW)

(73) Assignee: Sunrex Technology Corp., Ta Ya Shiang (TW)

(21) Appl. No.: 13/115,667

(22) Filed: May 25, 2011

(51) Int. Cl. H04B 7/00

(52) U.S. Cl. 455/41.3

(57) ABSTRACT

A Bluetooth data transmission system and method is provided. The system includes a computer comprising a USB port, a keyboard, and an embedded resident program; and a USB dongle releasably connected to the USB port for communicating with the computer, the USB dongle comprising a USB communication module, a MCU, a Bluetooth device communication module, and a USB-to-Bluetooth protocol translator. The USB communication module and the MCU are electrically interconnected, the MCU and the Bluetooth device communication module are electrically interconnected, the USB communication module is electrically connected to the computer for processing data input from the keyboard into USB data, the USB-to-Bluetooth protocol translator is disposed between the USB communication module and the Bluetooth device communication module for translating USB data to Bluetooth data and sending same to the Bluetooth device communication module, and the Bluetooth device communication module wirelessly transmits Bluetooth data to a portable electronic device.

### BACKGROUND OF THE INVENTION

1. Field of the Invention

The invention relates to data transmission and more particularly to a Bluetooth data transmission system and method.

2. Description of Related Art

Bluetooth is a proprietary open wireless technology standard for exchanging data over short distances by using short wavelength radio transmissions from fixed and mobile devices, creating personal area networks (PANs) with high levels of security. It was originally conceived as a wireless alternative to RS-232 data cables. It can connect several devices, overcoming problems of synchronization.

Bluetooth provides a secure way to connect and exchange information between devices such as faxes, mobile phones, telephones, laptop computers, personal computers (PCs), printers, Global Positioning System (GPS) receivers, digital cameras, and video game consoles.

Bluetooth have the following application: Wireless control of and communication between a mobile phone and a handsfree headset. Wireless networking between PCs in a confined space and where little bandwidth is required. Wireless communication with PC input and output devices, the most common being the mouse, keyboard, and printer. For low bandwidth applications where higher Universal Serial Bus (USB) bandwidth is not required and cable-free connection desired. Sending small advertisements from Bluetooth-enabled advertising hoardings to other discoverable Bluetooth devices. Dial-up internet access on personal computers or personal digital assistants (PDAs) using a data-capable mobile phone as a wireless modem. Real-time location systems (RTLS) are used to track and identify the location of objects in real-time using “Nodes” or “tags” attached to, or embedded in the objects tracked, and “Readers” that receive and process the wireless signals from these tags to determine their locations. Personal security application on mobile phones for prevention of theft or loss of items. The protected item has a Bluetooth marker (e.g. a tag) that is in constant communication with the phone. If the connection is broken (the marker is out of range of the phone) then an alarm is raised.

There is a Bluetooth keyboard capable of, not only being used as a wireless data transmission device but also being used as a typical wire data transmission device commercially available. The Bluetooth function of the keyboard can be activated for wirelessly transmitting data to a target (e.g., PC) when battery is charged and the USB function thereof can be activated for wire transmitting data to the target when battery is discharged (i.e., too low).

However, somewhat frequent plugging is required and this is cumbersome in use. Further, no disclosure of email sending and receiving between a PC having a USB dongle and a mobile phone when the PC is not connected to the Internet. Furthermore, no disclosure of email sending and receiving between a wireless keyboard having a USB dongle and a mobile phone. One drawback of sending or receiving emails by using a mobile phone is that size of texts and messages shown on LCD display thereof is relatively small. Moreover, keys of keypad of the mobile phone are small. Hence, a senior citizen or a person with poor eyesight may have difficulties of keying texts on the keypad to send an email or reading a received email when using a mobile phone. In addition, it is prone to error. Thus, the need for improvement still exists.

### SUMMARY OF THE INVENTION

It is therefore one object of the invention to provide a Bluetooth data transmission system comprising a computer comprising a USB port, a keyboard, a display, and an embedded resident program; and a USB dongle releasably connected to the USB port for communicating with the computer, the USB dongle comprising a USB communication module, a MCU (microcontroller unit), a Bluetooth device communication module, and a USB-to-Bluetooth protocol translator; wherein the USB communication module and the MCU are electrically interconnected, the MCU and the Bluetooth device communication module are electrically interconnected, the USB communication module is electrically connected to the computer for processing data input from the keyboard into USB data, the USB-to-Bluetooth protocol translator is disposed between the USB communication module and the Bluetooth device communication module for translating USB data from the USB communication module to Bluetooth data and sending Bluetooth data to the Bluetooth device communication module, and the Bluetooth device communication module is adapted to wirelessly transmit Bluetooth data to a portable electronic device.

It is another object of the invention to provide a Bluetooth data transmission method comprising the steps of (A) running a resident program stored in a computer; (B) determining whether a USB dongle has been found wherein step (B) loops back to step (A) if no USB dongle is found; (C) running the resident program to scan data input from a keyboard; (D) running the resident program to translates data into USB data wherein step (D) proceeds to step (E) and returns to step (C) respectively; (E) running the resident program to send USB data to the USB dongle, and activating a USB-to-Bluetooth protocol translator to translate USB data to Bluetooth data which is in turn sent to a Bluetooth device communication module; and (F) activating the Bluetooth device communication module to wirelessly transmit Bluetooth data to a portable electronic device.

It is a further object of the invention to provide a Bluetooth data transmission method comprising the steps of (A) running a resident program stored in a computer; (B) determining whether a USB dongle has been found wherein step (B) loops back to step (A) if no USB dongle is found; (C) determining whether data flow is directed the USB dongle or the computer wherein step (C) loops back to step (A) if the data flow is directed to the computer; (D) running the resident program to scan data input from a keyboard; (E) running the resident program to translates data into USB data wherein step (E) proceeds to step (F) and returns to step (D) respectively; (F) running the resident program to send USB data to the USB dongle, and activating a USB-to-Bluetooth protocol translator to translate USB data to Bluetooth data which is in turn sent to a Bluetooth device communication module; and (G) activating the Bluetooth device communication module to wirelessly transmit Bluetooth data to a portable electronic device.

The above and other objects, features and advantages of the invention will become apparent from the following detailed description taken with the accompanying drawings.

### BRIEF DESCRIPTION OF THE DRAWINGS

FIG. 1 is a perspective view of laptop computer and a resident program for showing a Bluetooth data transmission system according to the invention;

FIG. 2 is a block diagram of the Bluetooth data transmission system according to a first preferred embodiment of the invention;

FIG. 3 is a flow chart illustrating a Bluetooth data transmission method according to the first preferred embodiment of the invention;

FIG. 4 is a block diagram of the Bluetooth data transmission system according to a second preferred embodiment of the invention; and

FIG. 5 is a flow chart illustrating a Bluetooth data transmission method according to the second preferred embodiment of the invention.

### DETAILED DESCRIPTION OF THE INVENTION

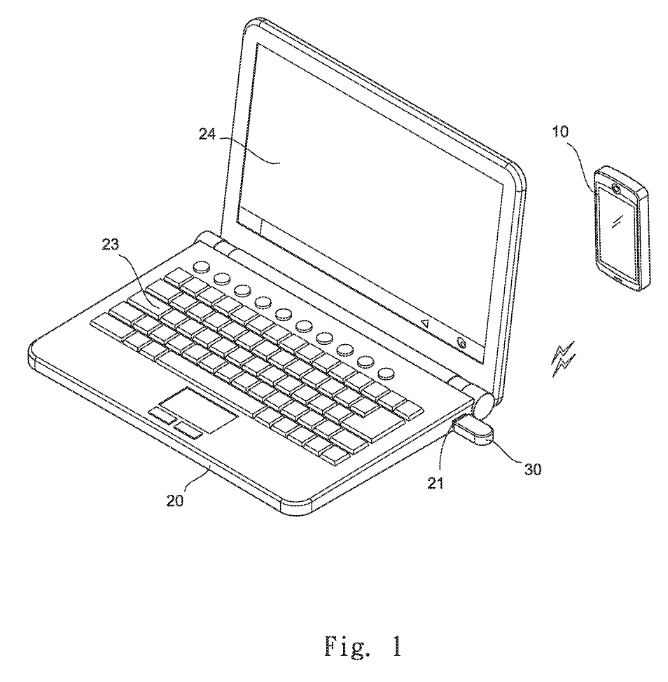

Referring to FIG. 1, a Bluetooth data transmission system in accordance with the invention in implemented by a portable electronic device 10 having an embedded antenna; a laptop computer 20 comprising a USB port 21 on the right side, a keyboard 23 on top, and a display (e.g., LCD (liquid crystal display) display) 24 hingedly connected to the main body of the laptop computer 20; and a USB dongle 30. While the portable electronic device 10 may be a tablet computer, a mobile phone, etc., the portable electronic device 10 is implemented as a smart phone in all embodiments of the invention described later.

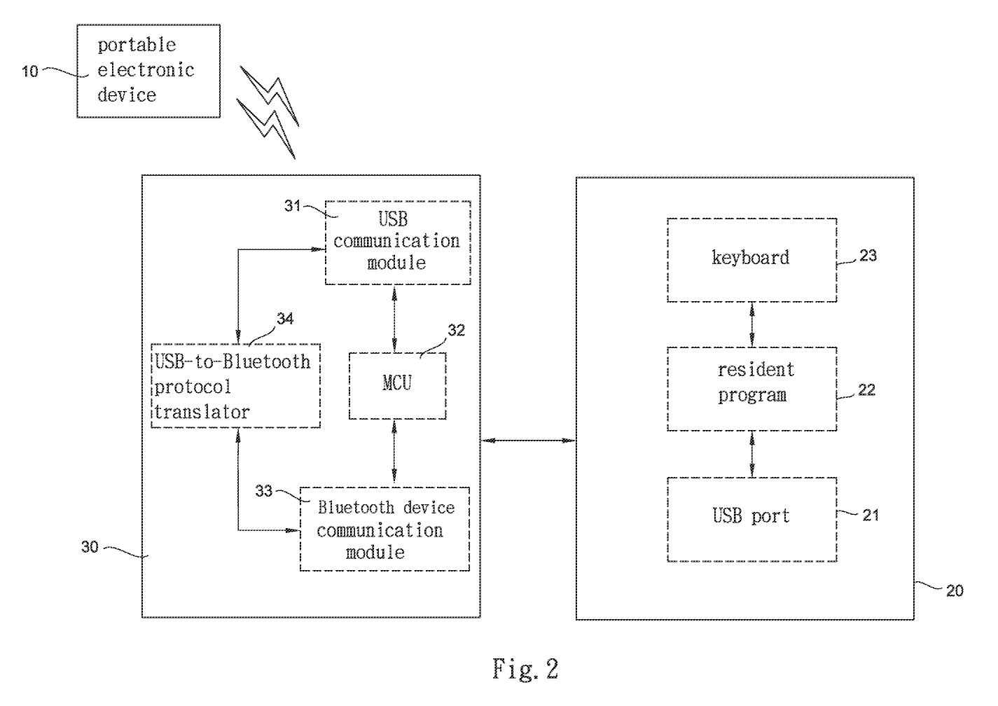

Referring to FIG. 2, a first preferred embodiment of the Bluetooth data transmission system in accordance with the invention is shown. The laptop computer 20 further comprises a resident program 22. The USB dongle 30 is implemented as an interface plug adapted to insert into the USB port 21 for electrically connecting to the laptop computer 20 for communication. The USB dongle 30 comprises a USB communication module 31, a MCU (microcontroller unit) 32, and a Bluetooth device communication module 33 in which the USB communication module 31 and the MCU 32 are electrically interconnected and the MCU 32 and the Bluetooth device communication module 33 are electrically interconnected. The MCU 32 is a single chip and has circuitry. The USB dongle 30 further comprises a USB-to-Bluetooth protocol translator 34 disposed between the USB communication module 31 and the Bluetooth device communication module 33. The USB-to-Bluetooth protocol translator 34 can translate USB data from the USB communication module 31 to Bluetooth data which is in turn sent to the Bluetooth device communication module 33. It is envisaged by the invention that the USB dongle 30 having Bluetooth device communication module 33 can be implemented as a Bluetooth interface for providing a Bluetooth wireless link between the laptop computer 20 and the portable electronic device 10.

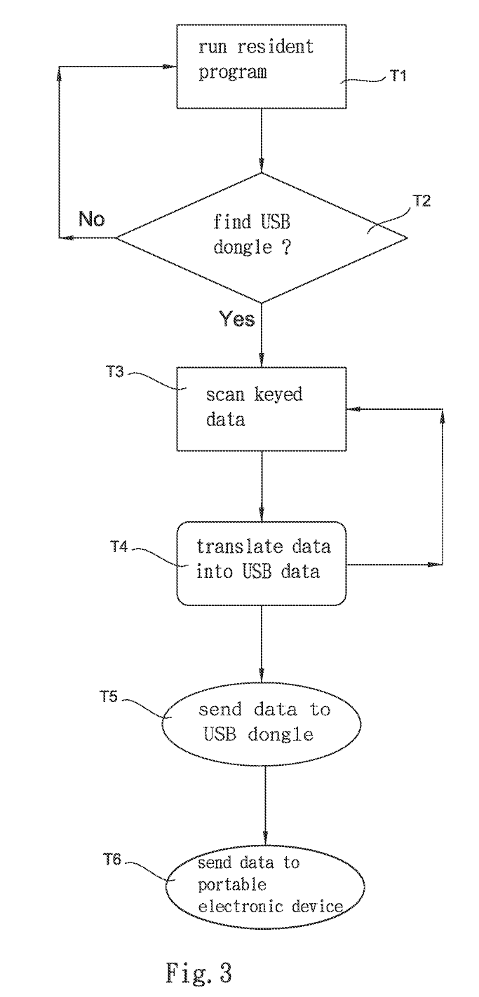

Referring to FIG. 3 in conjunction with FIGS. 1 and 2, a Bluetooth data transmission method in accordance with a first preferred embodiment of the invention is illustrated in a flow chart. The method comprises the following steps:

Step T1: After turning on the laptop computer 20, the resident program 22 in the laptop computer 20 begins to run.

Step T2: The resident program 22 attempts to find the USB dongle 30. The flow returns to step T1 if no USB dongle 30 is found with any data keyed in being sent back to the laptop computer 20. The flow proceeds to a next step if the USB dongle 30 is found.

Step T3: The resident program 22 runs to scan data input from the keyboard 23. The flow proceeds to a next step.

Step T4: The resident program 22 translates data into USB data. The flow proceeds to a next step and returns to step T3 respectively.

Step T5: The resident program 22 sends the USB data to the USB dongle 30. Further, the USB-to-Bluetooth protocol translator 34 translates the USB data from the USB communication module 31 to Bluetooth data which is in turn sent to the Bluetooth device communication module 33. The flow proceeds to a next step.

Step T6: The Bluetooth device communication module 33 wirelessly transmits the Bluetooth data to the portable electronic device 10 via an antenna thereof.

The flow may stop after removing the USB dongle 30.

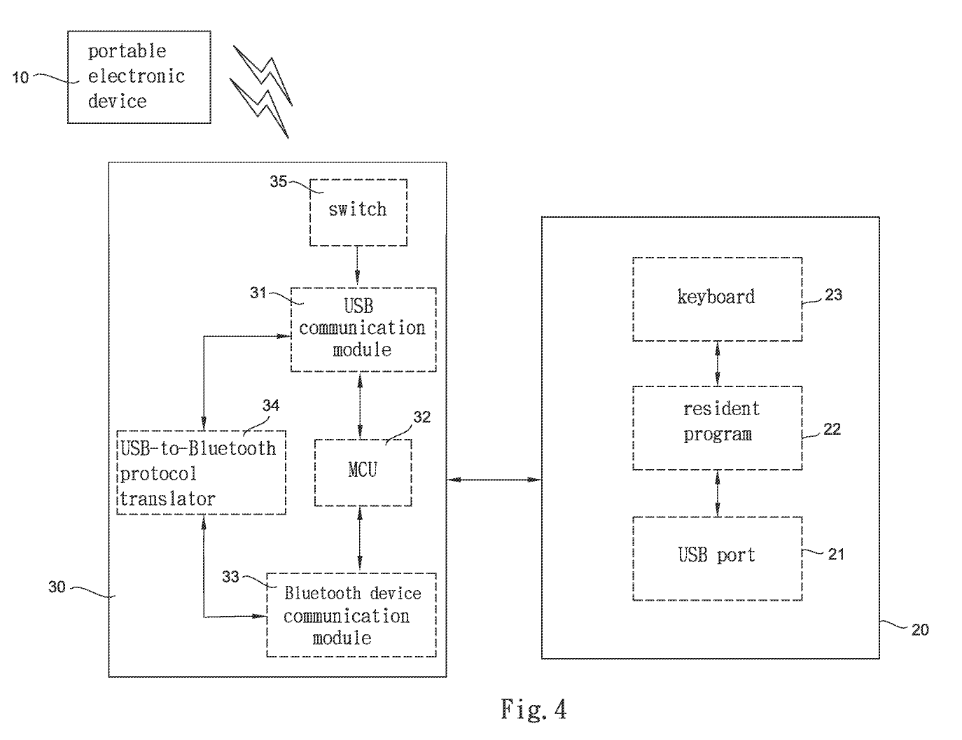

Referring to FIG. 4, a second preferred embodiment of the Bluetooth data transmission system in accordance with the invention is shown. The characteristics of the second preferred embodiment of the Bluetooth data transmission system are substantially the same as that of the first preferred embodiment except a switch 35 electrically connected to the USB communication module 31. The switch 35 may directs data flow to the USB dongle 30 or the laptop computer 20 by determination. The switch 35 may be a piece of hardware or implemented by firmware.

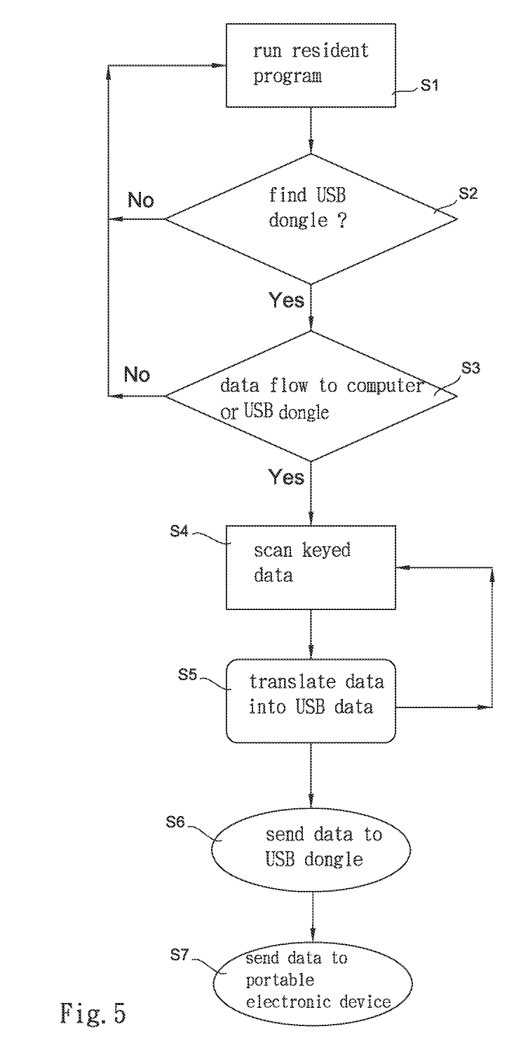

Referring to FIG. 5 in conjunction with FIGS. 1 and 4, a Bluetooth data transmission method in accordance with a second preferred embodiment of the invention is illustrated in a flow chart. The method comprises the following steps:

Step S1: After turning on the laptop computer 20, the resident program 22 in the laptop computer 20 begins to run.

Step S2: The resident program 22 attempts to find the USB dongle 30. The flow returns to step S1 if no USB dongle 30 is found with any data keyed in being sent back to the laptop computer 20. The flow proceeds to a next step if the USB dongle 30 is found.

Step S3: The switch 35 is operable to direct data flow to the USB dangle 30 or the laptop computer 20 by determination. The flow returns to step S1 to proceeds to a next step based on the result of the determination.

Step S4: The resident program 22 runs to scan data input from the keyboard 23. The flow proceeds to a next step.

Step S5: The resident program 22 translates data into USB data. The flow proceeds to a next step and returns to step S4 respectively.

Step S6: The resident program 22 sends the USB data to the USB dongle 30. Further, the USB-to-Bluetooth protocol translator 34 translates the USB data from the USB communication module 31 to Bluetooth data which is in turn sent to the Bluetooth device communication module 33. The flow proceeds to a next step.

Step S7: The Bluetooth device communication module 33 wirelessly transmits the Bluetooth data to the portable electronic device 10 via an antenna thereof.

The flow stops after removing the USB dongle 30 or deactivating the switch 35.

Alternatively, the laptop computer 20 can be replaced with a desktop computer in other embodiments. Still alternatively, the resident program 22 can be implemented by firmware in other embodiments.

Following is an exemplary example of the invention: A user may press keys of the keyboard 23 of the laptop computer 20 by watching the display 24 for email if the laptop computer 20 is not connected to the Internet. Then the email may be sent from the laptop computer 20 to the portable electronic device 10 via the USB dongle 30 over the Bluetooth wireless link. The user may find it easy since the display 24 is large and the keys of the keyboard 23 are also large. To the contrary, any emails received by the portable electronic device 10 may be sent to the display 24 of the laptop computer 20 for display via the USB dongle 30.

It is envisaged by the invention that any users, especially senior citizens or persons with poor eyesight, may find it easy to send or receive emails because the display 24 is large and the keys of the keyboard 23 are also large. In brief, typographical errors are decreased to a minimum.

While the invention has been described in terms of preferred embodiments, those skilled in the art will recognize that the invention can be practiced with modifications within the spirit and scope of the appended claims.

What is claimed is:

1. A Bluetooth data transmission system comprising:
a computer comprising a USB port, a keyboard, a display, and an embedded resident program; and
a USB dongle releasably connected to the USB port for communicating with the computer, the USB dongle comprising a USB communication module, a MCU (microcontroller unit), a Bluetooth device communication module, and a USB-to-Bluetooth protocol translator;
wherein the USB communication module and the MCU are electrically interconnected, the MCU and the Bluetooth device communication module are electrically interconnected, the USB communication module is electrically connected to the computer for processing data input from the keyboard into USB data, the USB-to-Bluetooth protocol translator is disposed between the USB communication module and the Bluetooth device communication module for translating USB data from the USB communication module to Bluetooth data and sending Bluetooth data to the Bluetooth device communication module, and the Bluetooth device communication module is adapted to wirelessly transmit Bluetooth data to a portable electronic device.

2. The Bluetooth data transmission system of claim 1, wherein the MCU is a single chip and has circuitry, the MCU is electrically interconnected USB communication module and the Bluetooth device communication module.

3. The Bluetooth data transmission system of claim 1, wherein the USB dongle is implemented as an interface plug adapted to insert into the USB port for electrically connecting to the laptop computer for communication, and wherein the USB dongle further comprises a switch for activating or deactivating the USB dongle, and directing data flow to the USB dongle or the computer.

4. A Bluetooth data transmission method comprising the steps of:
(A) running a resident program stored in a computer;
(B) determining whether a USB dongle has been found wherein step (B) loops back to step (A) if no USB dongle is found;
(C) running the resident program to scan data input from a keyboard;
(D) running the resident program to translates data into USB data wherein step (D) proceeds to step (E) and returns to step (C) respectively;
(E) running the resident program to send USB data to the USB dongle, and activating a USB-to-Bluetooth protocol translator to translate USB data to Bluetooth data which is in turn sent to a Bluetooth device communication module; and
(F) activating the Bluetooth device communication module to wirelessly transmit Bluetooth data to a portable electronic device.

5. The Bluetooth data transmission method of claim 4, wherein the USB dongle comprises a USB communication module, a MCU, a USB-to-Bluetooth protocol translator, and a Bluetooth device communication module; wherein the USB communication module and the MCU are electrically interconnected and the MCU, the Bluetooth device communication module are electrically interconnected, and the USB communication module is electrically connected to the computer for processing data input from the keyboard into USB data; and wherein the USB-to-Bluetooth protocol translator is disposed between the USB communication module and the Bluetooth device communication module for translating USB data from the USB communication module to Bluetooth data and sending Bluetooth data to the Bluetooth device communication module, and the Bluetooth device communication module is adapted to wirelessly transmit Bluetooth data to a portable electronic device.

6. The Bluetooth data transmission method of claim 4, wherein data input from the keyboard is sent back to the computer in response to deactivation or removal of the USB dongle.

7. The Bluetooth data transmission method of claim 4, wherein the resident program can be replaced with firmware.

8. A Bluetooth data transmission method comprising the steps of:
(A) running a resident program stored in a computer;
(B) determining whether a USB dongle has been found wherein step (B) loops back to step (A) if no USB dongle is found;
(C) determining whether data flow is directed the USB dongle or the computer wherein step (C) loops back to step (A) if the data flow is directed to the computer;
(D) running the resident program to scan data input from a keyboard;
(E) running the resident program to translates data into USB data wherein step (E) proceeds to step (F) and returns to step (D) respectively;
(F) running the resident program to send USB data to the USB dongle, and activating a USB-to-Bluetooth protocol translator to translate USB data to Bluetooth data which is in turn sent to a Bluetooth device communication module; and
(G) activating the Bluetooth device communication module to wirelessly transmit Bluetooth data to a portable electronic device.

9. The Bluetooth data transmission method of claim 8, wherein the USB dongle comprises a USB communication module, a MCU, a USB-to-Bluetooth protocol translator, and a Bluetooth device communication module; wherein the USB communication module and the MCU are electrically interconnected and the MCU, the Bluetooth device communication module are electrically interconnected, and the USB communication module is electrically connected to the computer for processing data input from the keyboard into USB data; and wherein the USB-to-Bluetooth protocol translator is disposed between the USB communication module and the Bluetooth device communication module for translating USB data from the USB communication module to Bluetooth data and sending Bluetooth data to the Bluetooth device communication module, and the Bluetooth device communication module is adapted to wirelessly transmit Bluetooth data to a portable electronic device.

10. The Bluetooth data transmission method of claim 8, wherein data input from the keyboard is sent back to the computer in response to deactivation or removal of the USB dongle.

11. The Bluetooth data transmission method of claim 8, wherein the USB dongle further comprises a switch for directing the data flow to the USB dongle or the computer.

12. The Bluetooth data transmission method of claim 8, wherein the resident program can be replaced with firmware.
